(19) United States
(12) Patent Application Publication
(10) Pub. No.: US 2022/0036320 A1
(43) Pub. Date: Feb. 3, 2022

(54) PREDICTION OF FAILURE RECOVERY TIMING IN MANUFACTURING PROCESS

(71) Applicant: Dell Products L. P., Round Rock, TX (US)

(72) Inventors: Shanir Anshul, Hyderabad (IN); Shibi Panikkar, Bangalore (IN)

(21) Appl. No.: 16/944,393

(22) Filed: Jul. 31, 2020

(51) Int. Cl. G06Q 10/00; G06N 20/10; G06Q 10/08

(52) U.S. Cl. CPC G06Q 10/20; G06Q 10/0837; G06Q 10/0833; G06N 20/10

(57) ABSTRACT

Methods, information handling systems and computer readable media are disclosed for formulating a proposed action involving a current repair process for a failed product in a manufacturing process. According to one embodiment, a method includes receiving identification of a current repair process and associating a first set of parameter values with the current repair process. The method further includes determining a likelihood of shipment delay resulting from the current repair process, where the determining includes applying a first machine learning model to the first set of parameter values. Based on the likelihood of shipment delay, the method further includes formulating a proposed action, including at least one of waiting for completion of the current repair process, replacing the failed product with an alternative product undergoing the manufacturing process, or initiating production of a new product to replace the failed product.

### BACKGROUND

The present disclosure relates generally to networked information handling systems, and more particularly to automated prediction of failure recovery timing in a manufacturing process.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Networked information handling systems can be configured for managing industrial manufacturing processes. For example, a factory management server can establish a shipping schedule for orders of manufactured products, where a single order may include multiple products to be shipped together. If the manufactured product is itself an information handling system or other complex product, the manufacturing process may include multiple stages, such as planning, gathering parts, building, testing, and packing. If a product fails during testing, it can be routed to a repair stage. Entry of one or more products from an order into a repair stage can introduce significant uncertainty for personnel responsible for making sure the order ships on time. Depending on customer relationships and agreements, there can be severe penalties for missing a planned shipping date for an order. A person responsible for the order shipment must decide whether to wait for the failed unit to be repaired, though this may cause the order to miss its shipment date, or try to find a replacement for the failed product.

### SUMMARY

Methods, information handling systems and computer readable media are disclosed for automatically formulating a proposed action involving a current repair process for a failed product in a manufacturing process. According to one embodiment, a method includes receiving identification of a current repair process and associating a first set of parameter values with the current repair process. The method further includes determining a likelihood of shipment delay resulting from the current repair process, where the determining includes applying a first machine learning model to the first set of parameter values. Based on the likelihood of shipment delay, the method further includes formulating a proposed action, including at least one of waiting for completion of the current repair process, replacing the failed product with an alternative product undergoing the manufacturing process, or initiating production of a new product to replace the failed product.

The foregoing is a summary and thus contains, by necessity, simplifications, generalizations and omission of detail; consequently those skilled in the art will appreciate that the summary is illustrative only and is not intended to be limiting. Other aspects, inventive features, and advantages, as defined solely by the claims, will become apparent in the non-limiting detailed description set forth below.

### BRIEF DESCRIPTION OF THE DRAWINGS

FIG. 1 is a flow chart illustrating certain aspects of an embodiment of a product production process.

FIG. 2 is a simplified block diagram illustrating an example of a network environment including multiple information handling systems, and suitable for implementing embodiments of the present disclosure.

FIG. 3 is a simplified block diagram illustrating certain components of an embodiment of an information handling system configured as a failure recovery system, according to an embodiment of the present disclosure.

FIG. 4 is a flow chart illustrating certain aspects of a method for predicting a degree of shipment delay resulting from a repair process and formulating a proposed action.

FIG. 5 is a flow chart illustrating certain aspects of a method for evaluating alternative products for potential replacement of a failed product.

FIG. 6 is a simplified block diagram illustrating certain aspects of an information handling system, according to an embodiment of the present disclosure.

### DETAILED DESCRIPTION

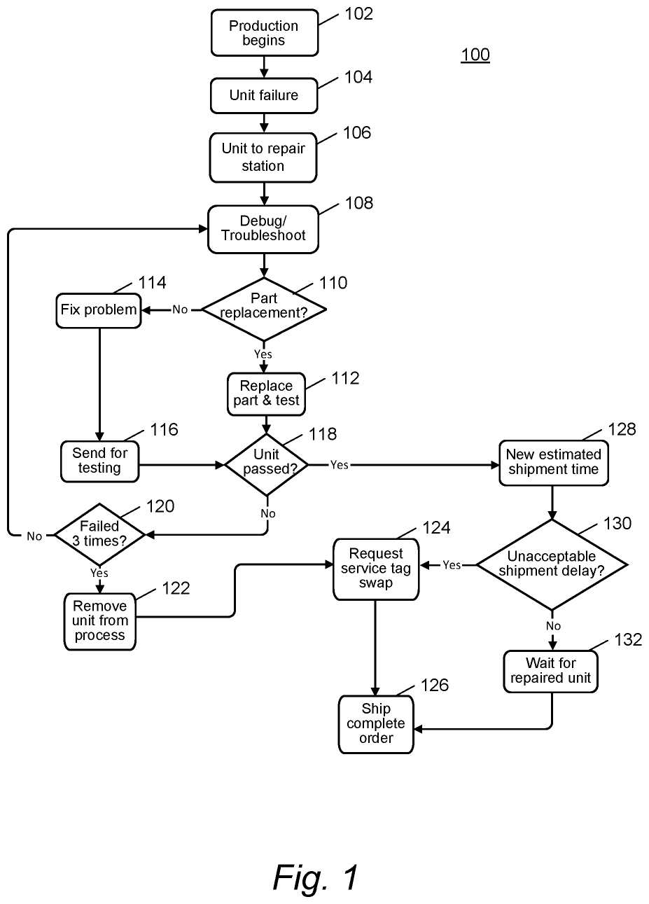

The flow chart of FIG. 1 illustrates some possible responses to discovery of a failed unit, or product, during a manufacturing process. Method 100 begins in step 102 with the start of the unit's production. At step 104, failure of the unit is discovered. For production of an information handling system or other electronic device, this discovery may occur in a “burn-in” phase of production. The failed unit is sent to a repair station in step 106, which begins a debugging or troubleshooting process in step 108. In an embodiment, the test station is operated by a human repair technician. If troubleshooting determines that a part replacement will solve the problem (“yes” branch of decision step 110), the part is replaced and the unit tested at step 112. If a defective part is not identified (“no” branch of step 110), the other problem causing the failure is repaired at step 114 and the unit sent for testing at step 116. Problems not involving a defective part replacement may in some embodiments be more subtle and time-consuming to diagnose and repair. In the embodiment of FIG. 1, the repair process is repeated for a unit not passing testing (“no” branches of decision steps 18 and 20) unless the unit fails after three attempts to repair and test it (“yes” branch of decision step 120).

If the repaired unit does pass testing (“yes” branch of step 118), a new estimate is made, at step 128, of when the unit will be ready to ship. This new shipment time estimate reflects the time needed to complete remaining stages of the manufacturing process once the repair has been completed. If this new shipment time will not give rise to an unacceptable shipping delay (“no” branch of decision step 130), the person responsible for shipping the relevant order can wait for the repaired unit to complete production (step 132) and proceed to shipping the complete order at step 126. If the new shipment time will give rise to an unacceptable delay (“yes” branch of step 130), a request can be made at step 124 to swap a different unit, identified in this embodiment by a service tag, in for the repaired unit. Whether a shipment delay caused by the repair is unacceptable may depend on various factors including but not limited to customer agreements, relative customer importance, or how often shipping is available to a given customer. A successful service tag swap depends on availability of another unit of the same product from a different order, where the unit to be swapped is farther along in the production process than the repaired unit, and where the order that the unit to be swapped is a part of will not be as severely impacted by the estimated shipment time of the repaired unit. If such a replacement unit can be found, the repaired unit is replaced by the replacement unit, and the complete order can then be shipped at step 126.

Returning to steps 118 and 120, if a repaired unit fails three times (“no” branch of step 118 and “yes” branch of step 120) it is removed from production in the embodiment of FIG. 1. A request for a product swap is made at step 124, and if a replacement product is found the complete order is shipped at step 126. Though not explicitly described in method 100, if a replacement product undergoing the manufacturing process is not available, production of a new product could be initiated to replace the product removed from production at step 122.

One difficulty with the process illustrated in FIG. 1 is that there is no evaluation of whether the planned shipment time will be missed until after the failed unit is repaired or removed from production. This can leave very little time to attempt to preserve the original shipment time by finding a suitable product for a swap. Another problem is the complexity of evaluating potential replacement devices for the service tag swap of step 124. It would be desirable to have a system capable of predicting soon after a repair process begins whether that repair is likely to result in an unacceptable shipment delay for the order associated with the failed device. It would further be desirable for the system to formulate one or more proposed actions, such as waiting for the repair process to complete, swapping the failed device with an identified replacement product, or initiating production of a new replacement product.

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

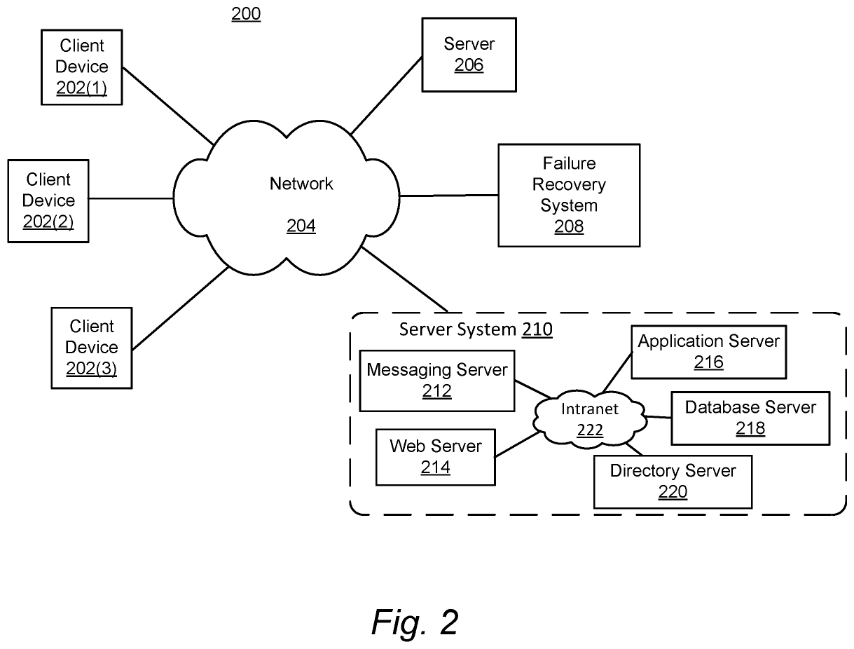

A network environment 200 including multiple networked information handling systems is shown in FIG. 2. In the embodiment of FIG. 2, client computing devices 202(1)-(3), server computing device 206, failure recovery system 208, and server system 210 are communicatively coupled to one another via network 204. Client computing devices 202(1)-(3), server 206 and failure recovery system 208 are embodiments of information handling systems as described above and elsewhere herein, and may take any of the various forms described, including personal computers, tablet computers, smartphones, or blade or rack devices, as appropriate.

In an embodiment, a client device 202 in communication with failure recovery system 208 represents a device operated by a person working at some stage of a manufacturing process. For example, a client device could be operated by the person responsible for shipment of an order including a failed device. A client device could also be operated by a repair technician assigned to repair the failed device, or a person participating in build, burn-in, testing or any other phase of the manufacturing process.

As noted above, an information handling system may include an aggregate of instrumentalities. For example, as used in this disclosure, “server” may include a server system such as server system 210, where a server system includes multiple networked servers configured for specific functions. As an example, server system 210 includes a messaging server 212, web server 214, application server 216, database server 218 and directory server 220, interconnected with one another via an intranet 222. Network 204 includes one or more networks suitable for data transmission, which may include local area networks (LANs), wide area networks (WANs), storage area networks (SANs), the Internet, or combinations of these. In an embodiment, network 204 includes a publicly accessible network, such as a public switched telephone network (PSTN), a DSL connection, a cable modem connection or large bandwidth trunks (e.g., communications channels providing T1 or OC3 service). Such networks may also include cellular or mobile telephone networks and other wireless networks such as those compliant with the IEEE 802.11 standards. Intranet 222 is similar to network 104 except for being, typically, private to the enterprise operating server system 210.

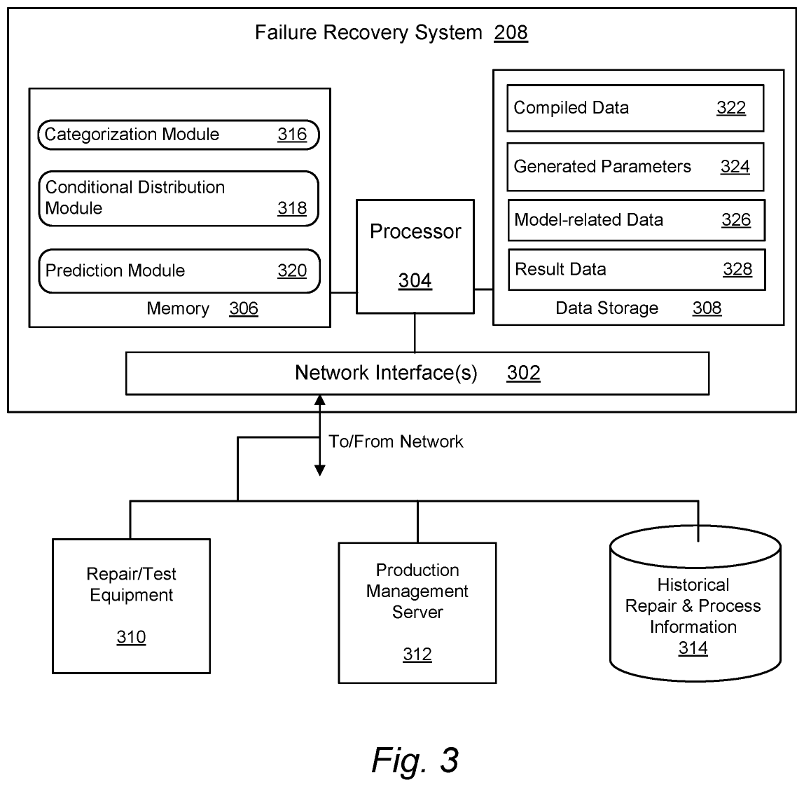

A block diagram illustrating certain components of an embodiment of failure recovery system 208 is shown in FIG. 3. Although illustrated as a single device in FIG. 3, the failure recovery system disclosed herein may also be implemented as a server system similar to server system 210 of FIG. 2. In the embodiment of FIG. 3, failure recovery system 208 includes one or more network interfaces 302, a processor 304, memory 306 and data storage 308. Memory 306 stores program instructions that when executed by processor 304 implement a categorization module 316, a conditional distribution module 318 and a prediction module 320. Data storage 308 is configured to store compiled data 322, generated parameters 324, model-related data 326 and result data 328.

Network interface 302 is configured for both sending and receiving of data and control information within a network. In an embodiment, network interface 302 comprises multiple interfaces and can accommodate multiple communications protocols and control protocols. Memory 306 includes a plurality of memory locations addressable by processor 304 for storing program instructions and data used in program execution. As such, memory 306 may be implemented using any combination of volatile or non-volatile memory, including random-access memory (RAM) and read-only memory (ROM). In an embodiment, memory 306 is system memory for processor 304. Data storage 308 includes one or more integrated or peripheral mass storage devices, such as magnetic disks, optical disks, solid state drives or flash drives. In other embodiments, or at other times during operation of the embodiment of FIG. 3, some or all of the instructions shown in memory 306 may be stored in data storage 308, and some or all of the data shown in data storage 308 may be stored in memory 306.

Categorization module 316 is configured to categorize stored information characterizing previous repair processes for products similar to a failed product. In the embodiment of FIG. 3, this type of stored information is represented as within historical repair and process information 314, accessed via network interface 302. In general, historical repair and process information 314 includes records of the types of failures encountered in previous repairs of the same or similar products, with the corresponding time required by the particular assigned repair technician to perform associated tasks or repairs. In an embodiment, the historical repair information includes failure codes and descriptions produced by one or more automated test systems used by repair personnel to evaluate a failed product. Table 1 includes some simplified sample data for an embodiment of historical repair data from historical repair and process information 314.

Table 1 includes sample data for repair of an information handling device. In the embodiment of Table 1, data is maintained for three individual repair technicians, Technicians A through C. Three different categories of task are included in the Inspection Type column: those using a simple diagnostic tool, those using a complex diagnostic tool, and repairs. For each task in the Failure/Task description column, a time taken by each technician to complete the task is shown in the corresponding column for that technician. In an embodiment, the task completion time is an average of times for multiple completions of the same task. In other embodiments, the task completion time is a time for a most recent completion of the task, or an average of multiple more recent completions of the task. Table 1 also includes an expected completion time for that task. In an embodiment, the expected completion time is expressed in terms of a service level agreement, or SLA. The data of Table 1 is simplified for purposes of explanation, and embodiments of historical repair and process information 314 include additional data, such as test system failure codes, types of failure or task, and scope of inspection performed. In an embodiment, some or all of repair data from historical repair and process information 314 is stored using a data format compatible with that of an automated test system used at a repair station associated with the manufacturing process.

TABLE 1

| | | Expected | Historical Time to Resolve | | |
|---|---|---|---|---|---|
| | | Comple- | Issue/Complete Task (Hours) | | |
| Inspection | Failure/Task | tion Time | Techni- | Techni- | Techni- |
| Type | Description | (Hours) | cian A | cian B | cian C |
| Simple | Can't power on | 6.0 | 4:12 | 5:25 | 4:52 |
| diagnostic | Card fail | 6.0 | 5:31 | 4:14 | 5:34 |
| tool | Replace chassis | 6.0 | 5:45 | 4:56 | 5:45 |
| | Replace | 6.0 | 4:12 | 5:15 | 4:12 |
| | motherboard | | | | |
| Specialized | Run | 8.0 | 7:19 | 7:34 | 6:59 |
| diagnostic | configuration | | | | |
| tool | test | | | | |
| | Hard disk | 8.0 | 7:34 | 7:12 | 7:47 |
| | damaged | | | | |
| | Reset memory | 8.0 | 7:49 | 6:52 | 6:51 |
| Repair | Reseat | 12.0 | 9:49 | 11:09 | 9:56 |
| | component | | | | |
| | Replace drive | | 11:12 | 11:49 | 10:34 |

Categorization module 316 applies a machine learning model to historical repair data along with information about the current repair process, in order to establish relevant categories for the data and classify the current repair process in terms of quantities including product involved, error or failure code assigned by automated test equipment, tasks required for diagnosis and repair, and time taken historically for resolving the problem. In an embodiment, the machine learning model is a support vector machine, but other machine learning classification models can be used in other embodiments. The machine learning model is trained using historical repair information from historical repair and process information 314. In an embodiment, the model training is updated periodically as more repair information is accumulated. The quantities determined by categorization module 316 characterize the current repair process and constitute input parameters for use by conditional distribution module 318, prediction module 320 or both.

In an embodiment, categorization module 316 provides a recommendation of one or more individual repair technicians best suited for assignment to the current repair process. This recommendation is based on the previous time performance of the repair technicians addressing problems similar to that presented by the current repair process. The problem presented by the current repair process is ascertained using data received from repair/test equipment 310 via network interface 302. Repair/test equipment 310 represents various automated testing and diagnostic systems in use during the manufacturing process. In an embodiment, equipment 310 includes test equipment used in a burn-in or testing phase of the process in which a failure may be discovered, as well as diagnostic equipment used by a repair technician after a failed product is brought to a repair station. In one embodiment, failure codes or other information from the test equipment initially discovering the device failure is used by categorization module 316. In such an embodiment, a repair technician recommendation or assignment can be made before the repair process starts. In another embodiment, information from diagnostic equipment used at a repair station is used by categorization module 316, either instead of or in addition to information from equipment used in the testing phase of the process.

Conditional distribution module 318 is configured to use data reflecting conditions of the current repair process to predict aspects of the performance of a current repair process. Conditional distribution module 318 calculates a probability that a particular repair technician will complete the current repair process within a time expected for the repair. In an embodiment, module 318 generates one or more conditional parameters for prediction module 320. An individual repair technician's performance can be affected by factory conditions at the time of the repair, such as how “busy” the repair department is. Conditional distribution module 318 employs a probability distribution function across multiple interrelated factors learned from training examples. In an embodiment, the probability distribution is a multinomial distribution in which a probability as dependent on multiple factors is determined as a product of probabilities with respect to the factors individually. As an example of such an embodiment, a probability distribution may be a function of five interrelated factors as follows.
1. An inspection type A, with values of Simple Tool, Specialized Tool or Repair (as shown in Table 1 above). In this embodiment, the type of inspection being performed affects a repair technician's efficiency E, described further below.
2. A production size S, reflecting the overall number of the relevant product that is being manufactured, with values of Low for a small or pilot production and High for a full or large production. The production size also affects efficiency.
3. A repair technician efficiency E, having values of Low and High. Efficiency depends on inspection type and production size in this embodiment. A technician may be more efficient performing a task using a simple tool than a task using a specialized tool, for example. A technician may be more efficient repairing a product that is part of a large production in some cases, because there may be more experience with that product than a product in a pilot or small production.
4. A volume O of units being repaired (or awaiting repair) at the time of the current repair process, having values of Low and High.
5. A response time T for completion of a given task by the assigned repair technician, having values of Within Required Time (for meeting the expected repair time or scheduled shipment time), At Required Time, and Above Required Time. In an embodiment, these values are alternatively expressed in terms of values required by a service level agreement (SLA) as Within SLA, SLA, and Above SLA. The response time is dependent on the volume O and efficiency E.

An embodiment of a probability distribution function P over the above factors can be expressed as

P(A,S,E,O,T)=P(A)*P(S)*P(E)*P(O)*P(T).

The individual probabilities are determined from historical repair and production data, received from historical repair and process information 314, in view of information about the current repair such as the product, repair task, and assigned repair technician. In an embodiment, current process conditions such as the product, production size and volume of units under repair are received from production management server 312, while current repair-related information such as the repair task and assigned repair technician is received from repair/test controller 310. For a given repair process having an assigned technician and a known product, production size, volume of units under repair, inspection type and inspection/repair task to be performed, a probability that the task will be completed within the expected time for the task can be calculated. In an embodiment, conditional distribution module 318 generates one or more related conditional parameters for prediction module 320. As an example, such a conditional parameter may be expressed as a fraction, of the products being repaired by the assigned technician at the current time, that are completed within the expected time (or, alternatively, are not completed within the expected time). The joint probability distribution function described above represents one embodiment of conditional distribution module 318. In other embodiments, module 318 can be implemented using a different model such as a Markov chain rule.

Prediction module 320 is configured to predict an amount of deviation from the scheduled shipping time for an order, resulting from a current repair process for a failed product from the order. Module 320 is also configured to formulate one or more proposed actions, including at least one of waiting for the current repair process to finish, swapping the failed product for a different product undergoing the manufacturing process, or initiating production of a new product to replace the failed product. In an embodiment, prediction module 320 employs a decision tree model. Inputs to module 320 can be grouped generally into parameters describing the failed product involved in the current repair process and parameters describing other products of the same model that are associated with different orders than the failed product.

In an embodiment, parameters describing the failed product include an identifier of the failed product, which may be referred to as a service tag number, or service tag. These parameters may also include an identifier of the order that the product is associated with, a failure code generated by automated test equipment during testing or inspection of the failed product, and an identifier of a repair technician assigned to the failed product. Additional parameters reflecting repair process status, such as time received in the repair queue, time leaving the repair process (if applicable), whether the product has been repaired, and the number of products in the repair queue, may also be inputs to module 320 in some embodiments. Historical repair times for the assigned repair technician, as discussed above in connection with the description of categorization module 316, are also inputs to module 320 in an embodiment. Parameters associated with repair times may include statistical quantities such as mean repair times or standard deviations for distributions of repair times. In an embodiment, inputs to module 320 also include one or more conditional parameters, characterizing repair of the failed product, generated by conditional distribution module 318.

The decision tree model of module 320 uses parameters describing the failed product to predict a delay resulting from the repair process. In an embodiment for which the product is an information handling system, this delay may be referred to as an electro-mechanical repair (EMR) deviation. Using an additional parameter of the time required to complete the remaining process phases (which may include, for example, burn-in, testing, packing) after the repair is finished, obtained from production management server 312, a shipment time resulting from waiting for the repair process to complete is predicted by module 320.

Parameters describing other products associated with different orders than that of the failed product are used by module 320 in identifying potential products for swapping with the failed product, in the event that repair of the failed product is predicted to cause an unacceptable delay. Data regarding orders undergoing the manufacturing process is received from production management server 312. Table 2 includes some simplified sample data describing orders in progress. In the embodiment of Table 2, each table row is for a different order of the same product model. The Manufacturing Stage columns indicate how many units within an order are at a given manufacturing stage, and how long that stage is expected to take, in hours and minutes, with the total number of units in the order shown in the rightmost column. Each order is also assigned a priority level of low (L), medium (M) or high (H). In an embodiment, the priority level is assigned as part of normal factory operation, and may be related to factors such as customer importance or shipping logistics associated with the order. Among the manufacturing stages, the Repair stage is entered only by units for which a failure is discovered. In the embodiment of Table 2, only two of the orders have a unit in the repair phase: Order Number 654321 and Order Number 456123.

TABLE 2

| | | | | Manufacturing Stage | | | | | | |
|---|---|---|---|---|---|---|---|---|---|---|
| | | Ship | Priority | Unit Count/Expected Time (HH:MM) | | | | | | Total |
| Model | Order | Date | Level | Plan | Kit | Build | Repair | Test | Box | Units |
| 123A | 123456 | 2020 May 19 | L | 5/24:40 | | | | | | 5 |
| 123A | 654321 | 2020 May 16 | H | | | 2/3:55 | 1/25:40 | | | 3 |
| 123A | 234561 | 2020 May 19 | H | 2/24:40 | | | | | | 2 |
| 123A | 543216 | 2020 May 19 | M | | | | | | 42/2:33 | 42 |
| 123A | 345612 | 2020 May 15 | M | | | | | | 46/2:33 | 46 |
| 123A | 432165 | 2020 May 15 | L | | 3/0:15 | | | | | 3 |
| 123A | 456123 | 2020 May 15 | L | | | | 1/25:40 | 1/1:25 | 10/2:33 | 12 |

The data of Table 2 is simplified for purposes of explanation; embodiments of factory order data received by prediction module 320 can have many more records and contain additional fields. For example, a production line identifier and product family identifier is included in some embodiments. Table 2 is an example list of orders with products of the same model as the failed product, so that a product suitable for a swap might be identified. In some embodiments, orders with products from the same product family could be listed. If the product is reconfigurable or modifiable, for example, a swap with a product of a different model may be possible if the product can be readily reconfigured to match one of a different model.

Table 3 includes parameters derived from or associated with the order data of Table 2 and used by prediction module 320. In an embodiment, Table 3 is an example of a data structure generated by prediction module 320. Table 3 includes the same order numbers as in Table 2, with corresponding values of parameters called Total Service Tags, Impacted Service Tags, More Critical Service Tags, and Order Priority Impact Rating.

TABLE 3

| | Total | Impacted | More Critical | |
|---|---|---|---|---|
| Order | Service | Service | Service | Order Priority Impact |
| No. | Tags | Tags | Tags | Rating |
| 123456 | 5 | 0 | 108 | 200 (L priority) + |
| | | | | 4 (4 day ship) = 204 |
| 654321 | 3 | 1 | 0 | 0 (H priority) + |
| | | | | 1 (next day ship) = 1 |
| 234561 | 2 | 0 | 0 | 0 (H priority) + |
| | | | | 4 (4 day ship) = 4 |
| 543216 | 42 | 0 | 53 | 100 (M priority) + |
| | | | | 4 (4 day ship) = 104 |
| 345612 | 46 | 0 | 0 | 100 (M priority) + |
| | | | | 0 (same day ship) = 100 |
| 432165 | 3 | 0 | 53 | 200 (L priority) + |
| | | | | 0 (same day ship) = 200 |
| 456123 | 12 | 1 | 53 | 200 (L priority) + |
| | | | | 0 (same day ship) = 200 |

The Total Service Tags column contains the number of units in the order, as also shown in the Total Units column of Table 2. The Impacted Service Tags column contains the number of units that have encountered an error, also shown as the number of units in the Repair column of Table 2. The More Critical Service Tags column contains a type of priority ranking: a number of other units of this model under production that are more critical than the units in this order. For the most critical orders, the number of more critical units is zero. In an embodiment, the number of more critical units is assigned as part of normal factory operation, external to the failure recovery system described herein. In the embodiment of Table 3, the orders designated as having zero more critical service tags are either orders given a High priority in the Priority Level column of Table 2, or orders given a Medium priority but having a same-day ship date. (Based on the dates in the Ship Date column of Table 2, Table 3 reflects the shipping lead times as of May 15, 2020.) The order in Table 3 with a Medium priority and a longer shipping lead time (4 days) is shown as having 53 more critical units, corresponding to the 53 units designated as having no units more critical. In this embodiment, the orders with a Low priority but a same-day ship date are designated as having the same number of more critical units as the Medium priority order. The order in Table 3 with a low priority and a longer shipping lead time is shown as having 108 more critical units, reflecting that number of more critical units in the table.

The Order Priority Impact Rating column of Table 3 contains another priority-related parameter. A lower Order Priority Impact Rating indicates a higher-priority order. In an embodiment, the Order Priority Impact Rating is assigned as part of normal factory operation, external to the failure recovery system described herein. This rating is generated by combining a value representing the order priority with a number of days until the order ships. In the embodiment of Table 3, a value of 0 is assigned to High priority orders, 100 to Medium priority orders, and 200 to Low priority orders. The particular priority parameters defined in Table 3 reflect one embodiment, and other priority parameter definitions may be used in other embodiments.

In an embodiment of prediction module 320, the parameters of Table 3 are provided to an artificial neural network created and updated using a backpropagation algorithm. The neural network produces parameters used by a decision tree model to determine whether there is a suitable unit to propose for a swap with the failed unit. In an embodiment, the parameters produced by the neural network include a current order priority, a repair impact rating, a supervisor priority, and a low priority fast shipment parameter. The current order priority in such an embodiment reflects a relative priority of a particular order as compared to other orders. In a further embodiment, parameters for an order are applied to the neural network if the order includes a unit in the repair queue, and the current order priority reflects a relative priority as compared to other orders including a unit in the repair queue. The repair impact rating, which may also be referred to as an EMR impact rating, reflects the impact of the assigned repair technician on the shipping delay caused by a repair. In an embodiment, a higher repair impact rating corresponds to a greater increase in the delay. The supervisor priority parameter is an operational priority level assigned by a supervisor in the factory. This parameter reflects specific situations that can cause a change in priority of one order compared to another, such as an upcoming shift change or a need to change a production line to handle a different product. In an embodiment, a higher supervisor priority parameter indicates a larger deviation from historical values in terms of predicting manufacturing time for an order. The low priority fast shipment parameter reflects a degree to which a lower priority order should be treated as a higher priority order because of a short shipping lead time.

Table 4 is an example of a correlation chart showing weighting factors relating the input variables for the decision tree model. In addition to the four parameters described above, the chart includes a service tag count parameter and a shipment lead time parameter. The Service Tag Count is a number of units associated with an order. In an embodiment, the Service Tag Count parameter is the number of units from a given order that are in the repair queue (also shown as Impacted Service Tags in Table 3). Shipment Lead Time is the time, in hours, remaining until an order is scheduled to ship. In an embodiment, each of the six parameter values included in Table 4 is scaled to a range between 0 and 10. The correlation factors listed in Table 4 establish relative weightings of the input parameters with respect to one another. In the embodiment of Table 4, for example, a weighting between the Service Tag Count and Shipment Lead time parameters is 0.64, while a weighting between the Current Order Priority and Supervisor Priority parameters is 0.72.

The weighting factors in Table 4 are periodically adjusted by testing model predictions against historical data, which is continually updated as products are manufactured. For example, predictions of time to complete a repair are compared to the actual repair time. In an embodiment, the factors are set and adjusted using a support vector machine. In another embodiment, the factors are applied as weights to nodes of an artificial neural network. For a given order, values of parameters including the parameters of Table 4 are used to draw a decision tree to determine whether a unit in the order is a good candidate for a swap with the failed product. In an embodiment, an output of the decision tree includes a probability that the scheduled shipment time can be met with a swap from the evaluated order. In such an embodiment, multiple swap candidates can be ranked in order of suitability.

TABLE 4

| | | | Current | Repair | |
|---|---|---|---|---|---|
| | Service | Shipment | Order | Impact | Supervisor |
| | Tag Count | Lead Time | Priority | Rating | Priority |
| Service Tag | | | | | |
| Count | | | | | |
| Shipment Lead | 0.64 | | | | |
| Time | | | | | |
| Current Order | 0.65 | 0.91 | | | |
| Priority | | | | | |
| Repair Impact | 0.49 | 0.71 | 0.68 | | |
| Rating | | | | | |
| Supervisor | 0.52 | 0.75 | 0.72 | 0.60 | |
| Priority | | | | | |
| Low Priority | 0.56 | 0.76 | 0.74 | 0.67 | 0.62 |
| Fast Shipment | | | | | |

Software modules and engines described herein may take various forms understood to one of ordinary skill in the art in view of this disclosure. A single module or engine described herein may in some embodiments be implemented by a combination of multiple files or programs. Alternatively or in addition, one or more functions associated with modules or engines delineated separately herein may be combined into a single file or program. In accordance with the interplay between modules such as modules 316, 318 and 320, parameters described as inputs to one of these modules may also be inputs to one or more of the other modules.

For ease of discussion, a device or module may be referred to as, for example, “performing,” “accomplishing,” or “carrying out” a function or process. The unit may be implemented in hardware and/or software. However, as will be evident to one skilled in the art, such performance can be technically accomplished by one or more hardware processors, software, or other program code executed by the processor, as may be appropriate to the given implementation. The program execution could, in such implementations, thus cause the processor to perform the tasks or steps instructed by the software to accomplish the desired functionality or result. However, for the sake of convenience, in the discussion herein, a processor or software component may be interchangeably considered as an “actor” performing the task or action described, without technically dissecting the underlying software execution mechanism.

Operation of modules 316, 318 and 320 is associated with storage, at least temporarily, of various types of data, including those shown within data storage 308 of failure recovery system 208. Compiled data 322 is data compiled from existing external sources for use in failure recovery system 208. The external sources have information including historical repair and process information and current process and repair status information. Examples of compiled data 322 include the data in Tables 1 and 2 above. Generated parameters 324 are parameters generated by a module within failure recovery system 208. Examples of such parameters are conditional parameters generated by conditional distribution module 318 for input to prediction module 320 and parameters such as the Current Order Priority and Repair Impact Rating of Table 4. Model-related data 326 is data associated with operation of the machine learning models used by system 208. One example of data 326 is properties of categories established by categorization module 316 in processing historic repair information, such as thresholds for “high” and “low” values of a category. Another example of model related data is a set of parameter weighting factors such as those shown in Table 4. Result data 328 includes results obtained by system 208, such as a shipping delay times incurred by a repair process or a probability that swapping an alternative product from a different order will allow a planned shipping time to be met. Result data 328 also includes one or more proposed actions to be presented or sent to a user of system 208.

In the embodiment of FIG. 3, failure recovery system 208 is connected to and utilizes data from associated systems and information stores, including repair/test equipment 310, production management server 312 and historical repair and process information 314. Repair/test equipment 310 includes automated test equipment used in diagnosing and testing a failed product. In an embodiment, equipment 310 includes multiple networked diagnosis or test systems. In a further embodiment, equipment 310 also includes testing equipment used in manufacturing phases other than repair, such as burn-in, test, or build phases. In an embodiment, equipment 310 sends data relating to ongoing or recent testing to failure recovery system 208. In another embodiment, another system such as production management server 312 manages data requests and transfers from equipment 310. Data from equipment 310 is incorporated into historical repair and process information 314.

Production management server 312 represents one or more servers configured to manage the product manufacturing process, including servers running applications such as a factory planning application. In an embodiment, server 312 sends data relating to ongoing production to failure recovery system 208. Such data includes details of orders being processed, including order numbers, product family and model identifiers, order priority level, planned shipment dates, numbers of units from an order in specific phases of the process, and expected cycle time for any or all of the process for a given order or unit. Data managed by production management server 312 is incorporated into historical repair and process information 314.

Historical repair and process information 314 represents one or more information stores containing historical repair information, such as that described in connection with repair/test equipment 310, and process information, such as that described in connection with production management server 312. In an embodiment, information 314 is managed by production management server 312. In another embodiment, information 314 is distributed among one or more information stores managed by repair/test equipment 310 and one or more information stores managed by production management server 312.

Further alternatives and variations of failure recovery system 208 will be apparent to one of ordinary skill in the art in view of this disclosure. For example, some or all of the modules depicted within memory 306 may be implemented using separate servers as part of a server system like system 210 of FIG. 2. Data depicted within data storage 308 may also be associated with one or more separate servers.

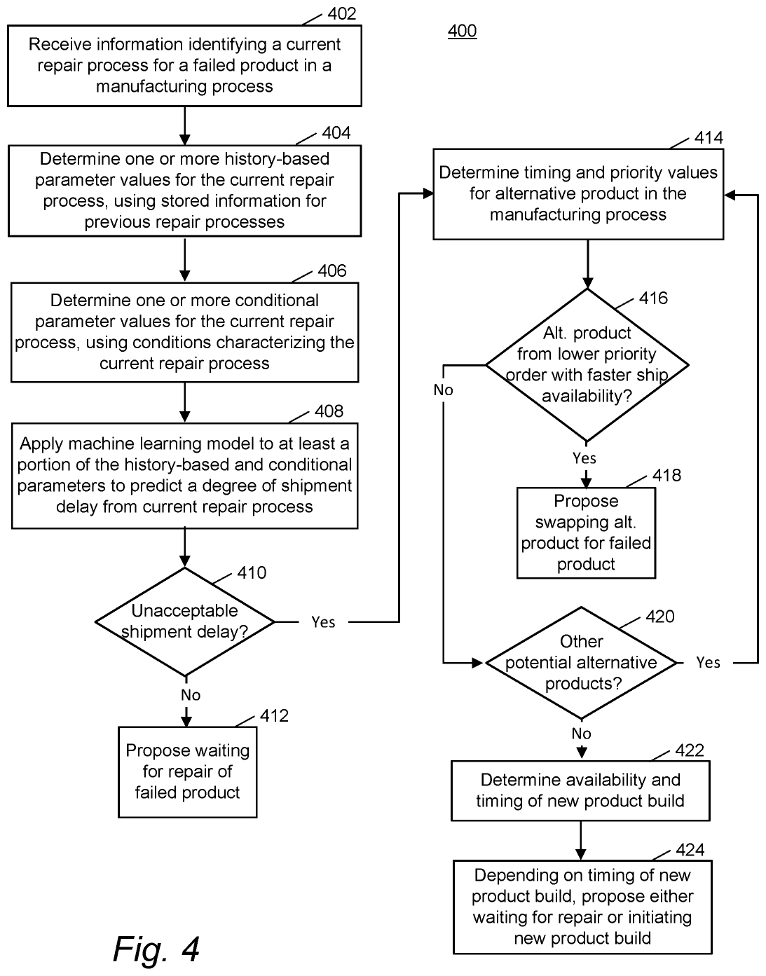

A flow chart illustrating an embodiment of a method carried out by failure recovery system 208 is shown in FIG. 4. Method 400 begins in step 402 with receiving information identifying a current repair process for a failed product in a manufacturing process. In one embodiment of method 400, the information is received from a user of failure recovery system 208, such as an employee responsible for shipment of the order containing the failed product. In another embodiment, the information is received automatically from a test system upon discovery that the product has failed a test. A test system providing information identifying the repair process is a test system at a repair station in some embodiments. In other embodiments, the test system is used in a production testing phase. In an embodiment, the information identifying the current repair process includes at least a product identifier such as a service tag, and an error identifier such as a failure code generated by a test system. In further embodiments, the information includes additional information, such as a product family identifier or an identifier of a technician assigned to the current repair process.

Method 400 continues in step 404 with determining one or more history-based parameter values for the current repair process, using stored information for previous repair processes. In an embodiment, step 404 is carried out by categorization module 316 of FIG. 3. Examples of history-based parameters for which values are determined in step 404 include product identity, repair task, error code, and time taken for the task by a given repair technician.

In step 406, the method continues with determining one or more conditional parameter values for the current repair process, using conditions characterizing the process. In an embodiment, step 406 is carried out by conditional distribution module 318 of FIG. 3. Examples of conditions characterizing the current repair process include a volume of units in the repair queue, a skill level of the assigned technician, and a size of the production including the failed product. An example of a conditional parameter is a probability that a technician will complete a repair task within the expected time for the task.

Method 400 continues in step 408 with applying a machine learning model to at least a portion of the history-based and conditional parameters to predict a degree of shipment delay from the current repair process. In an embodiment, step 408, along with the remaining steps of method 400 discussed below, is carried out by prediction module 320, in a manner described above in connection with discussion of FIG. 3. In an embodiment, the machine learning model is a decision tree model. In a further embodiment, both a neural network and a decision tree model are applied.

If the amount of shipment delay is not unacceptable (“no” branch of decision step 410), the method ends at step 412 with a proposal to wait for completion of the current repair process. In an embodiment, proposing waiting for the repair includes communicating the proposal to a user of failure recovery system 208. For example, the proposed action is sent to a display screen of system 208 in one embodiment. In another embodiment, the proposed action is sent in an electronic message to a user of system 208. Whether a delay is acceptable depends on factors such as customer agreements, customer importance, and logistics of shipping to a particular customer. In one embodiment, information is maintained by production management server 312 regarding an acceptable degree of shipping delay for a given order. In another embodiment, the amount of shipping delay predicted in step 408 is communicated to a user of failure recovery system 208, and a decision as to whether the delay is acceptable is received from the user.

If the predicted amount of shipping delay is unacceptable (“yes” branch of step 410), method 400 continues in step 414 with determining timing and priority values for an alternative product in the manufacturing process. The alternative product, from a different order than the failed product, is a product of the same model or configuration, or a product that can be readily reconfigured to match the failed product. In an embodiment, the timing and priority values are received from production management server 312. An example of such timing and priority value data is the data of Table 2 above. Based on the timing and priority value data, a determination is made as to whether the alternative product is from a lower priority order with faster shipment availability (decision step 416). In an embodiment, this determination is made by prediction module 320, in a manner described above in connection with discussion of FIG. 3.

If the evaluated alternative product is from a lower priority order with faster ship availability (“yes” branch of step 416), the method ends in step 418 with proposing a swap of the alternate product for the failed product. In an embodiment, the proposal is communicated to a user of failure recovery system 208 in a manner similar to that described for step 412 above. If the evaluated alternative product is not a good candidate for a swap (“no” branch of step 416), steps 414 and 416 are repeated for any other potential alternative products (“yes” branch of decision step 420). If no suitable product is found for a swap (“no” branch of step 420), method 400 continues in step 422 with determining availability and timing of starting a new build of a replacement product. Factors determining availability of a new build include continued availability, for the time required, of a production line configured to build that product. In an embodiment, the availability and timing information are received from production management server 312. Based on the availability and timing information, the method ends in step 424 with proposing either initiation of a new build of a replacement product or waiting for the current repair process to complete. In an embodiment, the proposal is communicated to a user of failure recovery system 208 in a manner similar to that described for steps 412 and 418 above.

In the embodiment of FIG. 4, decisions are made for each product in turn regarding suitability of alternative products for swapping, and a swap is proposed as soon as a suitable alternative product is found. In an alternative embodiment, a parameter reflecting suitability for a swap is generated for each alternative product, and a preferred product, or group of multiple preferred products, is selected prior to proposing a swap. Such a selection could be made by ranking the alternative products based on the suitability parameter, for example. Additional modifications, alternatives and variations to the methods described herein will be apparent to one of ordinary skill in the art in view of this disclosure.

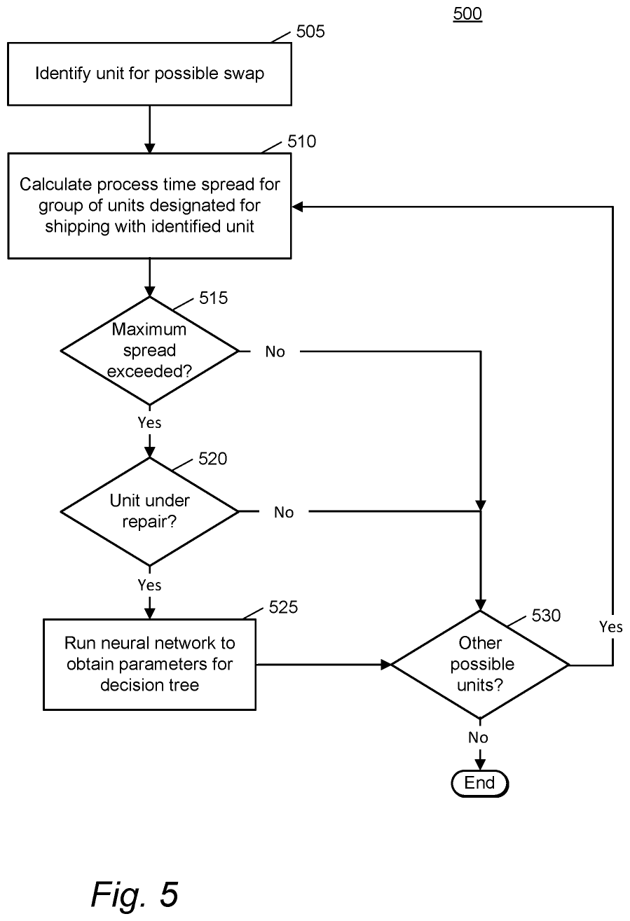

A flow chart illustrating an embodiment of another method that may be carried out by failure recovery system 208 is shown in FIG. 5. Method 500 is directed toward evaluation of products for potential swap with a failed product undergoing repair. As such, method 500 can be used in carrying out steps 414 and 416 of method 400 in FIG. 4. Method 500 begins at step 505 with identifying a unit for possible swap. In an embodiment, a list of orders similar to that of Table 2 above is obtained from production management server 312. Specifically, a list of orders for the same model or configuration of product is obtained, and units within each order on the list are considered for a possible swap.

Method 500 continues in step 510 with calculating a process time spread for a group of units designated for shipping with the identified unit. The process time spread, which may also be referred to as a “time distance,” is a difference, in time to complete a manufacturing phase, between the fastest and slowest moving units of the same order (or other group designated for shipping together) passing through that phase. A maximum allowed time distance between each phase can be determined for a given product using historical process data. If the maximum time spread is exceeded (“yes” branch of decision step 515) and the identified unit is under repair (“yes” branch of decision step 520), a neural network is created using a backpropagation algorithm, and the neural network is run at step 525 to obtain parameters for a decision tree. The neural network and decision tree models are discussed further above in connection with the description of prediction module 320 in FIG. 3. Steps 510 through 525 are repeated for any remaining units identified for a possible swap.

The failure recovery system and methods disclosed herein result in improved recovery from product testing failures in a manufacturing process. Use of machine learning allows improved prediction of performance of individual repair technicians, resulting in increased efficiency of the repair process and shorter repair queues. Use of machine learning also provides improved accuracy of shipping time predictions so that product swap decisions are more accurate and shipping queues are shorter. The improved efficiency and shortening of queues throughout the manufacturing process improves the operation of computer-implemented systems throughout the factory by freeing up system resources such as queue memory.

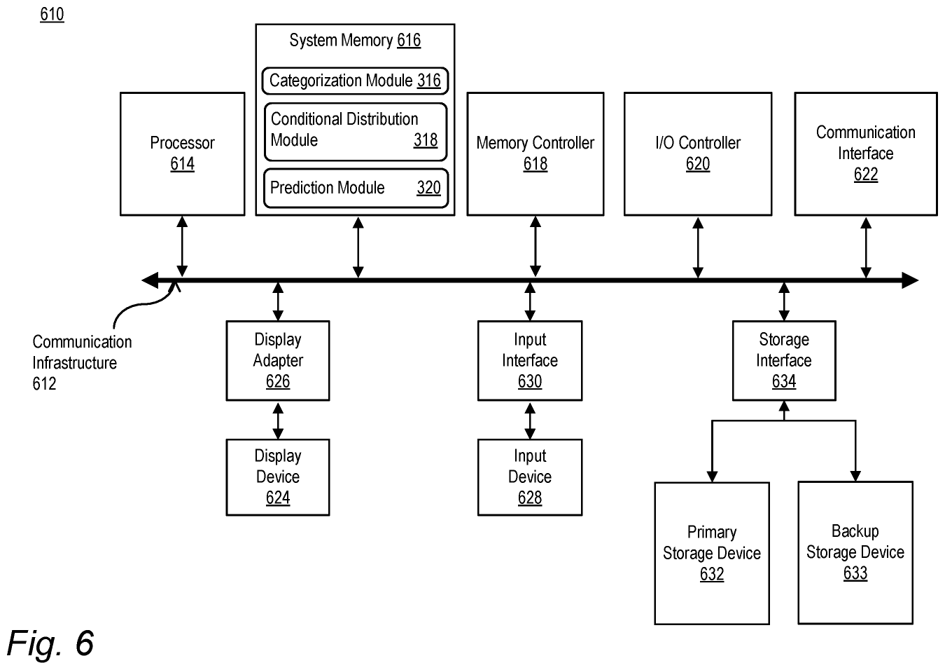

FIG. 6 depicts a block diagram of an information handling system 610 suitable for implementing aspects of the systems described herein. In the embodiment of FIG. 6, computing system 610 implements a failure recovery system such as system 208 of FIG. 2. Embodiments of the computing system of FIG. 6 can, alternatively or in addition, implement various other engines and modules described in this disclosure. Computing system 610 broadly represents any single or multi-processor computing device or system capable of executing computer-readable instructions. Examples of computing system 610 include, without limitation, any one or more of a variety of devices including workstations, personal computers, laptops, client-side terminals, servers, distributed computing systems, handheld devices (e.g., personal digital assistants and mobile phones), network appliances, switches, routers, storage controllers (e.g., array controllers, tape drive controller, or hard drive controller), and the like. In its most basic configuration, computing system 610 may include at least one processor 614 and a system memory 616. By executing the software that implements failure recovery system 208, computing system 610 becomes a special purpose computing device that is configured to formulate a proposed action in manners described elsewhere in this disclosure.

Processor 614 generally represents any type or form of processing unit capable of processing data or interpreting and executing instructions. In certain embodiments, processor 614 may receive instructions from a software application or module. These instructions may cause processor 614 to perform the functions of one or more of the embodiments described and/or illustrated herein. System memory 616 generally represents any type or form of volatile or non-volatile storage device or medium capable of storing data and/or other computer-readable instructions. Examples of system memory 616 include, without limitation, random access memory (RAM), read only memory (ROM), flash memory, or any other suitable memory device. The ROM or flash memory can contain, among other code, the Basic Input-Output System (BIOS) which controls basic hardware operation such as the interaction with peripheral components. Although not required, in certain embodiments computing system 610 may include both a volatile memory unit (such as, for example, system memory 616) and a non-volatile storage device (such as, for example, primary storage device 632, as described further below). In one example, program instructions executable to implement a categorization module 316, conditional distribution module 318 and prediction module 320 may be loaded into system memory 616.

In certain embodiments, computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI express (PCIe), or similar bus) and a network.

Memory controller 618 generally represents any type or form of device capable of handling memory or data or controlling communication between memory and one or more components of computing system 610. For example, in certain embodiments memory controller 618 may control communication between processor 614, system memory 616, and I/O controller 620 via communication infrastructure 612. In certain embodiments, memory controller 618 may perform and/or be a means for performing, either alone or in combination with other elements, one or more of the operations or features described and/or illustrated herein. I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

Communication interface 622 broadly represents any type or form of communication device or adapter capable of facilitating communication between computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 11054 host adapters, Serial Advanced Technology Attachment (SATA) and external SATA (eSATA) host adapters, Advanced Technology Attachment (ATA) and Parallel ATA (PATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

As illustrated in FIG. 6, computing system 610 may also include at least one display device 624 coupled to communication infrastructure 612 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer) for display on display device 624. Computing system 610 may also include at least one input device 628 coupled to communication infrastructure 612 via an input interface 630. Input device 628 generally represents any type or form of input device capable of providing input, either computer or human generated, to computing system 610. Examples of input device 628 include, without limitation, a keyboard, a pointing device, a speech recognition device, or any other input device.

As illustrated in FIG. 6, computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may include a magnetic disk drive (e.g., a so-called hard drive), a floppy disk drive, a magnetic tape drive, an optical disk drive, a flash drive, or the like. Storage interface 634 generally represents any type or form of interface or device for transferring data between storage devices 632 and 633 and other components of computing system 610. A storage device like primary storage device 632 can store information such as routing tables and forwarding tables.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may be a part of computing system 610 or may in some embodiments be separate devices accessed through other interface systems. Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6.

Computing system 610 may also employ any number of software, firmware, and/or hardware configurations. For example, one or more of the embodiments disclosed herein may be encoded as a computer program (also referred to as computer software, software applications, computer-readable instructions, or computer control logic) on a non-transitory computer-readable storage medium. Examples of computer-readable storage media include magnetic-storage media (e.g., hard disk drives and floppy disks), optical-storage media (e.g., CD- or DVD-ROMs), electronic-storage media (e.g., solid-state drives and flash media), and the like. Such computer programs can also be transferred to computing system 610 for storage in memory via a network such as the Internet or upon a carrier medium. The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the embodiments described and/or illustrated herein. Additionally or alternatively, one or more of the embodiments described and/or illustrated herein may be implemented in firmware and/or hardware. For example, computing system 610 may be configured as an application specific integrated circuit (ASIC) adapted to implement one or more of the embodiments disclosed herein.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

Although the present disclosure includes several embodiments, the claimed invention is not intended to be limited to the specific forms set forth herein. On the contrary, it is intended to cover such alternatives, modifications, and equivalents as can be reasonably included within the scope defined by the appended claims.

What is claimed is:

1. A method, comprising:
receiving identification of a current repair process, within a manufacturing process, for a failed product associated with a first scheduled shipment;
associating a first set of parameter values with the current repair process, wherein one or more of the parameter values within the first set are obtained using information characterizing previous repair processes for products similar to the failed product;
predicting a degree of shipment delay, resulting from the current repair process, for the first scheduled shipment, wherein predicting the degree of shipment delay comprises applying a first machine learning model to the first set of parameter values; and
based on the degree of shipment delay, formulating a proposed action, wherein the proposed action comprises at least one of waiting for completion of the current repair process,
replacing the failed product with an alternative product undergoing the manufacturing process, wherein the alternative product is associated with a second scheduled shipment, or
initiating production of a new product to replace the failed product.

2. The method of claim 1, wherein
formulating the proposed action comprises applying the first machine learning model to a second set of parameter values; and
one or more of the parameter values within the second set are obtained using information characterizing a product undergoing the manufacturing process but not associated with the first scheduled shipment.

3. The method of claim 1, wherein the first machine learning model comprises a decision tree model.

4. The method of claim 1, wherein
one or more of the parameter values in the first set are obtained using a second machine learning model; and
the second machine learning model is adapted to categorize the information characterizing previous repair processes.

5. The method of claim 4, wherein the second machine learning model comprises a support vector machine.

6. The method of claim 1, wherein
the first set of parameter values comprises one or more conditional parameter values; and
the conditional parameter values are obtained using information characterizing the current repair process.

7. The method of claim 6, wherein the conditional parameter values are obtained using a conditional distribution model.

8. The method of claim 1, further comprising sending a description of the proposed action to a display screen of an information handling system.

9. The method of claim 1, further comprising sending a message describing the proposed action.

10. An information handling system, comprising:
one or more processors;
one or more non-transitory computer-readable storage media coupled to the one or more processors; and
a plurality of instructions, encoded in the one or more computer-readable storage media and configured to cause the one or more processors to
receive identification of a current repair process, within a manufacturing process, for a failed product associated with a first scheduled shipment,
associate a first set of parameter values with the current repair process, wherein one or more of the parameter values within the first set are obtained using information characterizing previous repair processes for products similar to the failed product,
predict a degree of shipment delay, resulting from the current repair process, for the first scheduled shipment, wherein predicting the degree of shipment delay comprises applying a first machine learning model to the first set of parameter values, and
based on the degree of shipment delay, formulate a proposed action, wherein the proposed action comprises at least one of waiting for completion of the current repair process,
replacing the failed product with an alternative product undergoing the manufacturing process, wherein the alternative product is associated with a second scheduled shipment, or
initiating production of a new product to replace the failed product.

11. The information handling system of claim 10, wherein
the plurality of instructions is further configured to cause the one or more processors to apply the first machine learning model to a second set of parameter values, as a part of formulating the proposed action, and
one or more of the parameter values within the second set are obtained using information characterizing a product undergoing the manufacturing process but not associated with the first scheduled shipment.

12. The information handling system of claim 10, wherein
one or more of the parameter values in the first set are obtained using a second machine learning model; and
the second machine learning model is adapted to categorize the information characterizing previous repair processes.

13. The information handling system of claim 10, wherein
the first set of parameter values comprises one or more conditional parameter values; and
the conditional parameter values are obtained using information characterizing the current repair process.

14. The information handling system of claim 10, further comprising a display screen coupled to the one or more processors, and wherein the plurality of instructions is further configured to cause the one or more processors to send a description of the proposed action to the display screen.

15. The information handling system of claim 10, wherein the plurality of instructions is further configured to cause the one or more processors to send a message describing the proposed action.

16. A non-transitory computer readable storage medium having program instructions encoded therein, wherein the program instructions are executable to:
receive identification of a current repair process, within a manufacturing process, for a failed product associated with a first scheduled shipment,
associate a first set of parameter values with the current repair process, wherein one or more of the parameter values within the first set are obtained using information characterizing previous repair processes for products similar to the failed product,
predict a degree of shipment delay, resulting from the current repair process, for the first scheduled shipment, wherein predicting the degree of shipment delay comprises applying a first machine learning model to the first set of parameter values, and
based on the degree of shipment delay, formulate a proposed action, wherein the proposed action comprises at least one of waiting for completion of the current repair process,
replacing the failed product with an alternative product undergoing the manufacturing process, wherein the alternative product is associated with a second scheduled shipment, or
initiating production of a new product to replace the failed product.

17. The computer readable storage medium of claim 16, wherein
the program instructions are further executable to apply the first machine learning model to a second set of parameter values, as a part of formulating the proposed action, and
one or more of the parameter values within the second set are obtained using information characterizing a product undergoing the manufacturing process but not associated with the first scheduled shipment.

18. The computer readable carrier medium of claim 16, wherein
one or more of the parameter values in the first set are obtained using a second machine learning model; and
the second machine learning model is adapted to categorize the information characterizing previous repair processes.

19. The computer readable carrier medium of claim 16, wherein
the first set of parameter values comprises one or more conditional parameter values; and
the conditional parameter values are obtained using information characterizing the current repair process.

20. The computer readable carrier medium of claim 16, wherein the program instructions are further executable to send a message describing the proposed action.
